(19) United States
(12) Patent Application Publication
(10) Pub. No.: US 2018/0140403 A1
(43) Pub. Date: May 24, 2018

(54) MOLDED TIP WEAR GAUGE

(71) Applicant: DENTSPLY SIRONA Inc., York, PA (US)

(72) Inventors: Philip LAURITO, Harrisburg, PA (US); Kenneth R. GUARAGNO, Spring Grove, PA (US)

(73) Assignee: DENTSPLY SIRONA Inc., York, PA (US)

(21) Appl. No.: 15/817,565

(22) Filed: Nov. 20, 2017

Related U.S. Application Data
(60) Provisional application No. 62/425,228, filed on Nov. 22, 2016.

(51) Int. Cl. A61C 17/20; A61C 19/04

(52) U.S. Cl. CPC A61C 17/20; A61C 2204/007; A61C 19/04

(57) ABSTRACT

Described is a molded gauge used for both manual and automated inspection of the length of at least one ultrasonic scaler tip.

Disclosed herein is a molded gauge used for both manual and automated inspection of the length of at least one ultrasonic scaler tip.

A molded gauge may be designed to secure and present ultrasonic scaling tips so that the active portion of the tip (approximately the last 2 mm of length) can be visible in a through hole site window. The complex geometry of the tip gets captured in a molded profile that corresponds to the tip. This molded profile locates the tip, presents the working end in the site window, and identifies bent tips by preventing installation.

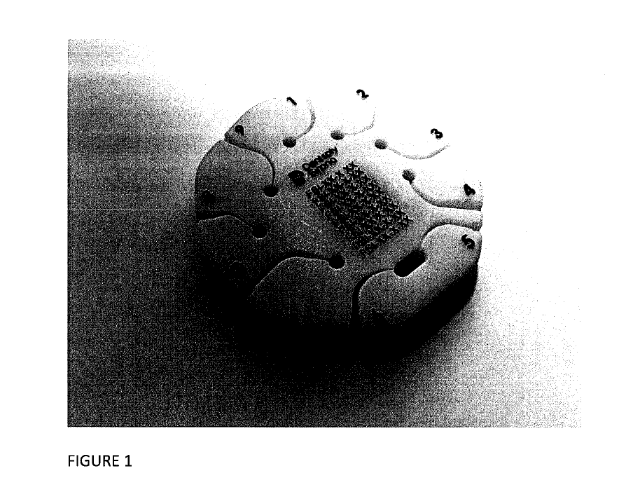

FIG. 1 demonstrates an ultrasonic tip gauge that is suitable to determine the wear on multiple different ultrasonic scaling tips.

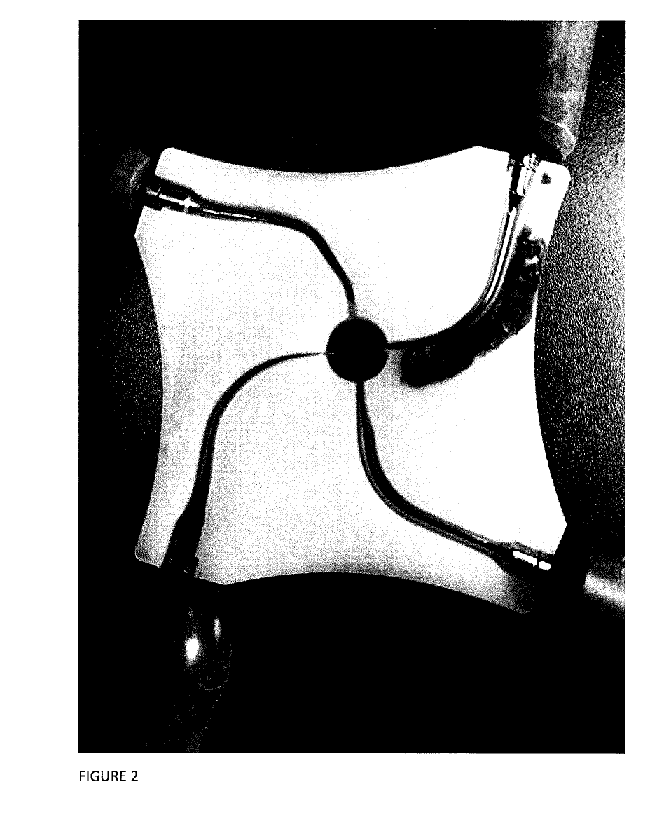

FIG. 2 demonstrates an another embodiment of an ultrasonic tip gauge where ultrasonic scaling tips are placed in the gauge and the tip is visible through a hole site window.

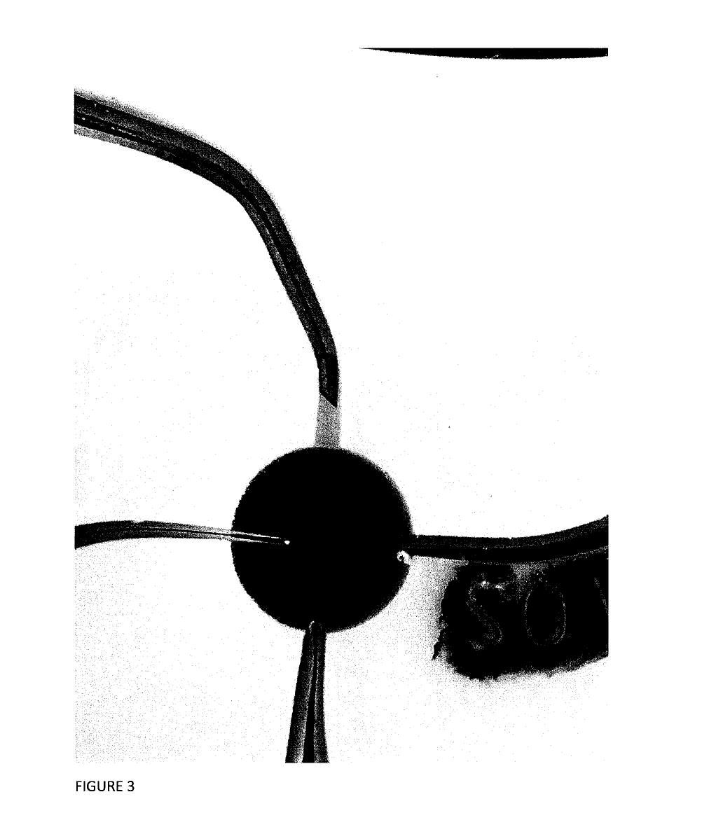

FIG. 3 is a close up view of FIG. 2.

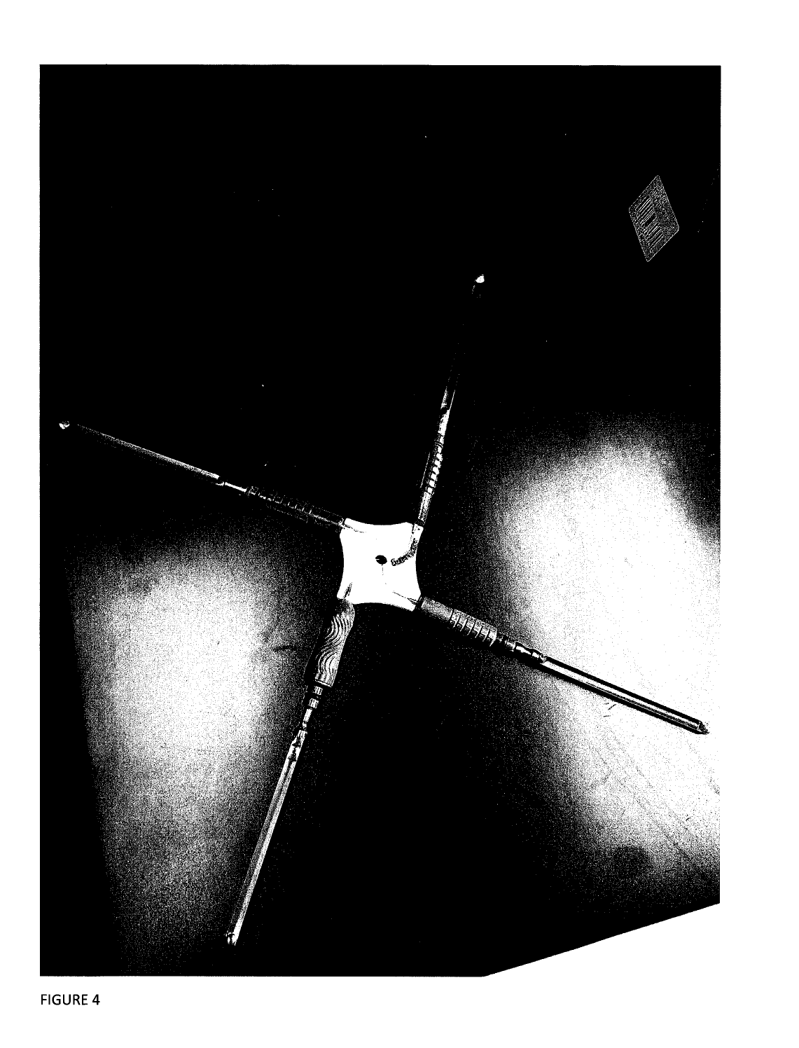

FIG. 4 is distant view of FIG. 2.

FIG. 5 is another embodiment of an ultrasonic tip gauge disclosed herein.

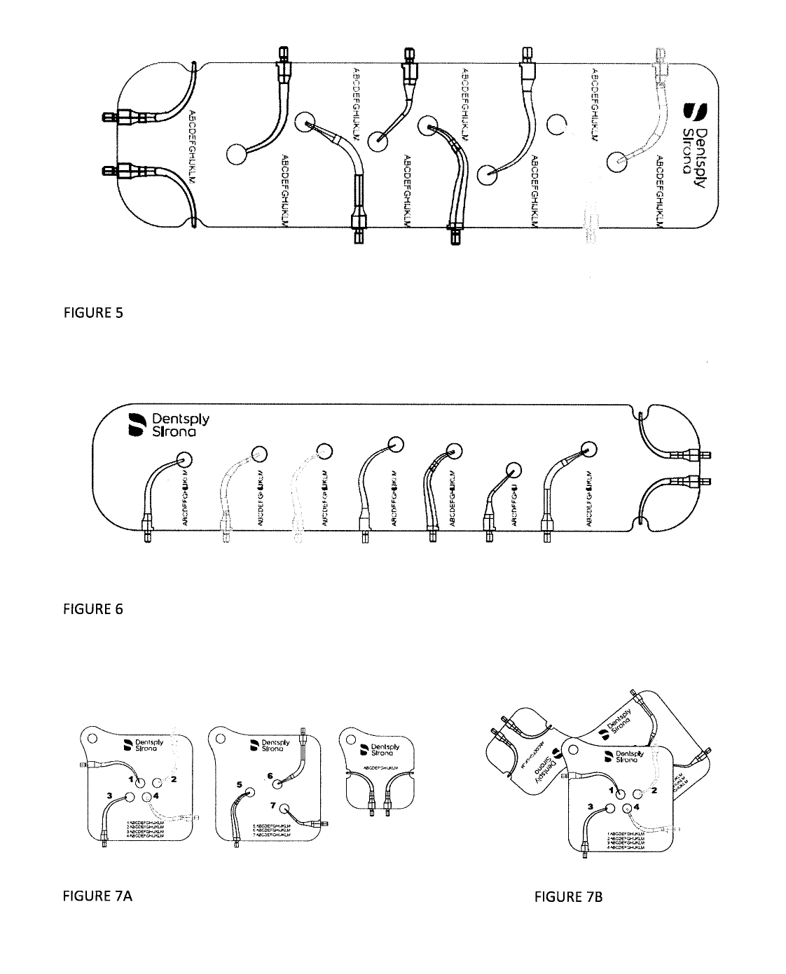

FIG. 6 is yet another embodiment of an ultrasonic tip gauge disclosed herein.

FIG. 7A and 7B demonstrate another embodiment of ultransonic tip gauge disclosed herein where the gauge is arranged in a keychain form such that different sized ultrasonic tips fit within different cards as shown in FIG. 7A and can be arranged in a stacked key chain manner as shown in FIG. 7B.

The molded tip gauge can be made of a plastic material such as polypropylene, PEEK, UItem, or the like, or any material that is suitable for steam autoclaving and chemical disinfection. Additionally the molded tip gauge can be made from an elastomeric material such as silicone rubber with a high durometer such as shore A 80-90. A rubber molded part may be present to provide flexibility for minor variation in tip profile.

Once an ultrasonic insert is mated to its respective profile the active portion, the approximately 2 mm distal end of the instrument, should protrude into a site window. If the tip is visible in the site window it should be considered in proper working condition. However as the tip wears it will no longer extend beyond the molded profile into the site window. The site window provides a simple and easily understood indication of tip length.

In addition to providing a manual tip wear indication the molded tip gauge can also be used in conjunction with a tip wear application on a smart phone or tablet or other suitable device. An image captured by the device camera can be post processed to determine the presence of the tip in the site window and the length of the tips extension into the site window. By intimately mating the tip to a molded tip gauge many advantages are realized. The tip gauge can provide fiducial markings, for example two or more site windows can be used to determine the scale of the image. The scale of the image is dependent on the distance that the device is held from the insert tip. By adjusting the scale, a more accurate measurement of tip wear can be made without the need for fixing the distance between the camera and the insert, such as with a fixture. Furthermore the tip gauge could provide visual ques, printed symbols or other molded features that the device can use to know which tip it is imaging. This will reduce post processing time and more quickly report the exact length of the tip.

We claim:

1. An ultrasonic scaling tip measuring gauge comprising a hollow portion that fits and secures ultrasonic scaling tip, and a hole site window to better view the active portion of the ultrasonic scaling tip.

2. An ultrasonic scaling tip measuring gauge according to claim 1, wherein the gauge is made of a plastic material or an elastomeric material.

3. An ultrasonic scaling tip measuring gauge according to claim 1, where the measuring of the active portion of the ultrasonic device occurs manually or with an application on a device.
